(19) United States
(12) Patent Application Publication
(10) Pub. No.: US 2025/0280447 A1
(43) Pub. Date: Sep. 4, 2025

(54) RANDOM ACCESS IN ASYMMETRIC TRANSMISSION AND RECEPTION POINT (TRP) DEPLOYMENTS

(71) Applicant: Lenovo (United States) Inc., Morrisville, NC (US)

(72) Inventor: Khaled Nafez Rauf ARDAH, Ilmenau (DE)

(21) Appl. No.: 19/192,065

(22) Filed: Apr. 28, 2025

(51) Int. Cl. H04W 74/0833; H04B 7/06; H04W 72/21

(52) U.S. Cl. CPC H04W 74/0833; H04B 7/06952; H04W 72/21

(57) ABSTRACT

Various aspects of the present disclosure relate to random access procedures for asymmetric transmission and reception point (TRP) deployments, such as when a user equipment (UE) is in a radio resource control (RRC)-idle mode of operation. The disclosure provides random access procedures for a UE, where available TRPs have different or asymmetric configurations (e.g., one TRP being applicable for downlink (DL) and uplink (UL) and one TRP being applicable for only UL). For example, the UE may transmit a random access preamble and receive a random access response message that identifies the configurations of available TRPs. Based on the identified configurations, the UE may perform random access and connect, or re-connect, with a network.

### TECHNICAL FIELD

The present disclosure relates to wireless communications, and more specifically to performing random access in asymmetric transmission and reception point (TRP) deployments.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In the wireless communications system, a user communication device and a network communication device may support random access (RA), for example, to establish a connection between the user communication device and the network communication device. In some cases, one or both of the user communication device and the network communication device may support time division duplexing (TDD), in which resources may be split (e.g., allocated, scheduled, divided) between uplink (UL) resources and downlink (DL) resources in a time domain. The user communication device can utilize configured time-frequency resource occasions to transmit a preamble and initiate an RA procedure.

### SUMMARY

As used herein, including the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.

As used herein, including in the claims, a “set” may include one or more elements.

The present disclosure relates to methods, apparatuses, processors, and systems that enable the performance of random access in asymmetric transmission and reception point (TRP) deployments. The methods, apparatuses, processors, and systems of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may comprise at least one memory and at least one processor coupled with the at least one memory and configured to cause the UE to transmit one or more random access preambles, receive a random access response message based at least in part on the one or more transmitted random access preambles, wherein the received random access response message indicates one or more identifiers or one or more sets of configurations, wherein each identifier and each set of configurations corresponds to a respective TRP of at least two TRPs, wherein at least one set of configurations for the respective TRP is applicable for downlink and uplink, or wherein the at least one set of configurations for the respective TRP is applicable for uplink, and transmit a physical uplink shared channel (PUSCH) transmission to at least one TRP based at least in part on a respective identifier of the at least one TRP or in accordance with the at least one set of configurations for the respective TRP that is indicated in the received random access response message.

A processor for wireless communication is described. The processor may be configured to, capable of, or operable to perform one or more operations as described herein. For example, the processor may comprise at least one memory and at least one controller coupled with the at least one memory and configured to cause the processor to transmit one or more random access preambles, receive a random access response message based at least in part on the one or more transmitted random access preambles, wherein the received random access response message indicates one or more identifiers or one or more sets of configurations, wherein each identifier and each set of configurations corresponds to a respective TRP of at least two TRPs, wherein at least one set of configurations for the respective TRP is applicable for downlink and uplink, or wherein the at least one set of configurations for the respective TRP is applicable for uplink, and transmit a PUSCH transmission to at least one TRP based at least in part on a respective identifier of the at least one TRP or in accordance with the at least one set of configurations for the respective TRP that is indicated in the received random access response message.

A method performed or performable by the UE is described. The method may comprise transmitting one or more random access preambles, receiving a random access response message based at least in part on the one or more transmitted random access preambles, wherein the received random access response message indicates one or more identifiers or one or more sets of configurations, wherein each identifier and each set of configurations corresponds to a respective TRP of at least two TRPs, wherein at least one set of configurations for the respective TRP is applicable for downlink and uplink, or wherein the at least one set of configurations for the respective TRP is applicable for uplink, and transmitting a PUSCH transmission to at least one TRP based at least in part on a respective identifier of the at least one TRP or in accordance with the at least one set of configurations for the respective TRP that is indicated in the received random access response message.

In some implementations of the UE, processor, and method described herein, the UE, processor, and method may further be configured to, capable of, performed, performable, or operable to receive system information from a first TRP of the at least two TRPs, wherein the system information indicates that the first TRP is associated with a second TRP of the at least two TRPs, wherein the first TRP is associated with a first set of configurations applicable for downlink and uplink, and wherein the second TRP is associated with a second set of configurations applicable for uplink, wherein the one or more random access preambles are transmitted to the at least two TRPs based at least in part on the received system information and using at least one beam or at least two beams, wherein each beam is associated with one or both of the at least two TRPs.

In some implementations of the UE, processor, and method described herein, the system information further indicates one or more of a slot pattern associated with the second TRP, a valid random access occasion associated with the second TRP, an invalid random access occasion associated with the second TRP, a valid PUSCH occasion associated with the second TRP, or an invalid PUSCH occasion associated with the second TRP.

In some implementations of the UE, processor, and method described herein, the system information comprises a system information block one (SIB1), wherein the SIB1 includes at least one information element (IE) comprising a Boolean type, wherein a first Boolean value for the IE is indicative of the first TRP being associated with a second TRP, and wherein a second Boolean value for the IE is indicative of the first TRP having no association to the second TRP.

In some implementations of the UE, processor, and method described herein, each set of configurations comprises one or more of a timing advance (TA) command, an uplink transmit beam index, a pathloss offset, or an uplink grant.

In some implementations of the UE, processor, and method described herein, the UE, processor, and method may further be configured to, capable of, performed, performable, or operable to identify a pathloss offset based at least in part on the received random access response message and determine a transmit power for the PUSCH transmission based at least in part on the identified pathloss offset, wherein the PUSCH transmission is transmitted to the at least one TRP according to the determined transmit power.

In some implementations of the UE, processor, and method described herein, the UE, processor, and method may further be configured to, capable of, performed, performable, or operable to identify at least two set of configurations based at least in part on the received random access response message, wherein a first set of configurations of the at least two set of configurations is applicable for downlink and uplink, and wherein a second set of configurations of the at least two set of configurations is applicable for uplink, wherein, to transmit to the at least one TRP, the at least one processor is further configured to cause the UE to transmit a first PUSCH transmission to a first TRP of the at least two TRPs in accordance with the first set of configurations and transmit a second PUSCH transmission to a second TRP of the at least two TRPs in accordance with the second set of configurations.

In some implementations of the UE, processor, and method described herein, the received random access response message includes at least one IE comprising a Boolean type that indicates whether the second TRP has a same set of configurations as the first TRP, wherein a first Boolean value for the IE is indicative of the second TRP having the same set of configurations as the first TRP, and wherein a second Boolean value for the IE is indicative of the second TRP having a different set of configurations than the first TRP.

In some implementations of the UE, processor, and method described herein, an absence of the IE comprising the Boolean type that indicates whether the second TRP has the same set of configurations as the first TRP from the received random access response message is indicative of the second TRP having the same set of configurations as the first TRP.

In some implementations of the UE, processor, and method described herein, the first set of configurations and the second set of configurations are the same.

In some implementations of the UE, processor, and method described herein, at least one set of configurations of the one or more sets of configurations is indicated as a fallback configuration set.

In some implementations of the UE, processor, and method described herein, the UE, processor, and method may further be configured to, capable of, performed, performable, or operable to transmit the PUSCH message to the at least one TRP based on the fallback configuration set when a Msg4 is not received within a pre-defined time window or in response to an indication within a received Msg4.

In some implementations of the UE, processor, and method described herein, the received random access response message includes an indication of a tdd-UL-DL-ConfigurationCommon defining slots pattern for at least one UL-only TRP of the at least two TRPs.

In some implementations of the UE, processor, and method described herein, the received random access response message includes a TRP-Type indication that indicates a provided configuration set is associated with a TRP having a UL-only time division duplex (TDD) pattern.

A network entity for wireless communication is described. The network entity may be configured to, capable of, or operable to perform one or more operations as described herein. For example, the network entity may comprise at least one memory and at least one processor coupled with the at least one memory and configured to cause the network entity to receive one or more random access preambles from a UE, and transmit, to the UE, a random access response message that includes one or more sets of configurations associated with a TRP index, wherein each set of configurations corresponds to a respective TRP of at least two TRPs within the TRP index, wherein at least one set of configurations for the respective TRP is applicable for downlink and uplink, or wherein the at least one set of configurations for the respective TRP is applicable for uplink.

A method performed or performable by the network entity is described. The method may comprise receiving one or more random access preambles from a UE, and transmitting, to the UE, a random access response message that includes one or more sets of configurations associated with a TRP index, wherein each set of configurations corresponds to a respective TRP of at least two TRPs within the TRP index, wherein at least one set of configurations for the respective TRP is applicable for downlink and uplink, or wherein the at least one set of configurations for the respective TRP is applicable for uplink.

In some implementations of the network entity and method described herein, the network entity and method may further be configured to, capable of, performed, performable, or operable to signal, via a system information block (SIB), an indication that a downlink (DL) serving TRP of a corresponding synchronization signal block (SSB) is associated with at least one UL-only TRP of the at least two TRPs, a tdd-UL-DL-ConfigurationCommon defining slots pattern of the at least one associated UL-only TRP, a valid RACH Occasion (RO) indicator validating and invalidating one or more ROs corresponding to the at least one UL-Only TRP, a valid PUSCH Occasion (PO) indicator validating and invalidating one or more POs corresponding to the at least one UL-Only TRP, or combinations thereof.

In some implementations of the network entity and method described herein, at least one set of configurations is indicated as a fallback configuration set.

In some implementations of the network entity and method described herein, each set of configurations contains a TA command, a UL grant, a UL transmit beam index, and a pathloss offset.

### BRIEF DESCRIPTION OF THE DRAWINGS

FIG. 1 illustrates an example of a wireless communications system in accordance with aspects of the present disclosure.

FIG. 2 illustrates an example asymmetric TRP deployment in accordance with aspects of the present disclosure.

FIG. 3 illustrates an example random access procedure in an asymmetric TRP deployment in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

### DETAILED DESCRIPTION

An asymmetric TRP deployment may involve multiple TRPs, such that one TRP supports both downlink (DL) and uplink (UL) transmissions with a UE (or UEs), while two or more additional TRPs support only uplink (UL) transmissions. For example, in an asymmetric TRP deployment with a single DL TRP (sTRP) and multiple UL TRP (mTRP), a UE may receive DL transmissions from a first network node (e.g., a TRP A) and transmit UL transmissions to multiple network nodes, such as the TRP A and a different, non-col-located network node (e.g., a TRP B). Such an asymmetric TRP deployment may provide various benefits, including enhanced UL throughput, reduced energy consumption (due to fewer DL transmissions), among other benefits.

Various aspects of the present disclosure relate to a random access procedure for asymmetric TRP deployments, such as when a UE is in a radio resource control (RRC) idle mode. For example, a UE may support a random access procedure in cases where available TRPs have different or asymmetric configurations (e.g., one TRP supporting both DL and UL communications, and another TRP supporting only UL communications). In RRC idle mode, the UE may perform a random access procedure to establish or re-establish a connection with a network, such as via a TRP (e.g., a base station) within an asymmetric TRP deployment. The UE may transmit a random access preamble and receive a random access response message that indicates the configurations of the available TRPs. Based on the identified configurations, the UE may select one of the available TRPs and transmit a PUSCH transmission to the selected TRP.

Thus, the UE may experience improvements in connecting to the network through an asymmetric TRP deployment, thereby providing the benefits, such as improved throughput and power saving, during random access procedures and in other scenarios where the UE is in an RRC idle or RRC inactive mode, among other benefits.

Aspects of the present disclosure are described in the context of a wireless communications system.

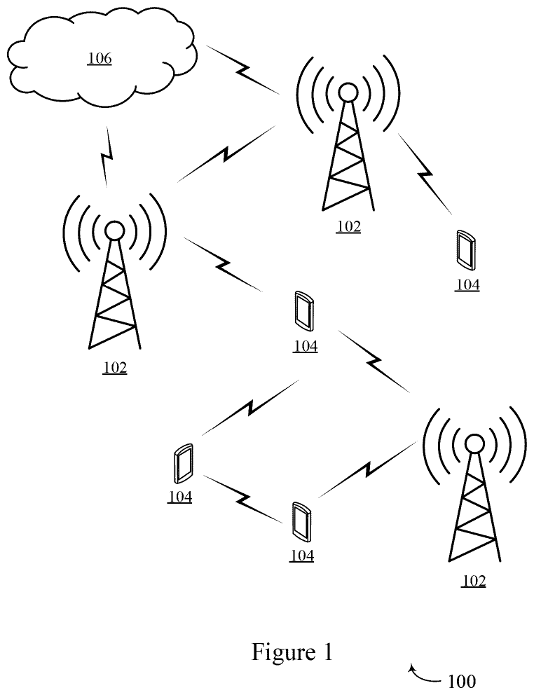

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., u=0) may be associated with a first subcarrier spacing (e.g., 15 kHz) and a normal cyclic prefix. In some implementations, the first numerology (e.g., u=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., u=2) may be associated with a third subcarrier spacing (e.g., 60 kHz) and a normal cyclic prefix or an extended cyclic prefix. A fourth numerology (e.g., u=3) may be associated with a fourth subcarrier spacing (e.g., 120 kHz) and a normal cyclic prefix. A fifth numerology (e.g., u=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., u=0, u=1, u=2, u=3, u=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., u=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, the wireless communications system 100 enables random access procedures for the UE 104 with respect to asymmetric TRP deployments. There are two types of random access procedures, Type 1 (e.g., 4-step random access) and Type 2 (e.g., 2-step random access), where Type 2 may reduce latency during random access by controlling signaling used during the procedure.

For example, in an unpaired spectrum operation (e.g., a time-division duplex (TDD) mode), the random access latency may be bounded or limited by a configured slot pattern (via the tdd-UL-DL-ConfigurationCommon), where a DL/UL heavy slot pattern provides less time resource opportunities for the UE 104 to transmit and/or receive random access messages.

A subband full-duplex (SBFD) framework enables frequency domain resources where DL or flexible slots may be subdivided into multiple DL-UL non-overlapping subbands, increasing the time resource opportunities for the UE 104 to transmit and receive random access messages. However, enabling random access in an asymmetric TRP deployment (e.g., DL sTRP UL mTRP) may further reduce random access latency, since deployed UL-only TRPs do not suffer from self-interference (e.g., with respect to SBFD) case and may have more UL time-frequency resources, reducing the random access latency and UL transmit power.

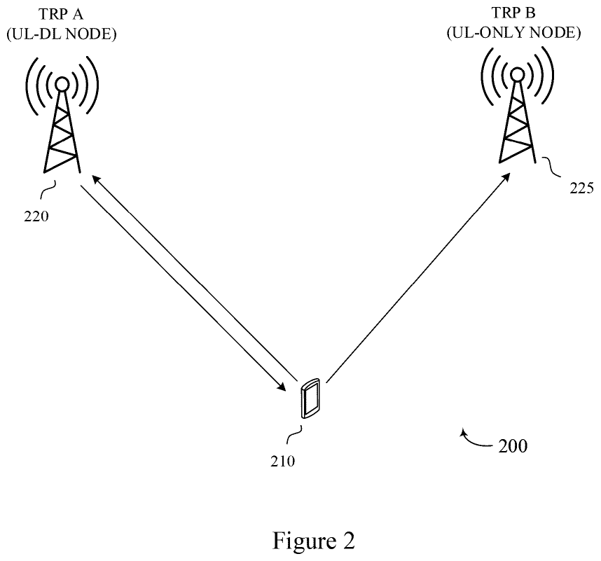

FIG. 2 illustrates an example asymmetric TRP deployment 200 in accordance with aspects of the present disclosure. A UE 210 may perform communication (e.g., transmit wireless communication and/or receive wireless communication) with multiple TRPs, including a first TRP 220 (e.g., a TRP A), which support (e.g., configured for or applicable for) both UL and DL communications, and a second TRP 225 (e.g., a TRP B), which only supports (e.g., only configured for or only applicable for) UL communications).

The UE 210 may perform random access by initiating a connection with a single network node (e.g., the TRP 220), which transmits reference signals (RSs), such as synchronization signal blocks (SSBs), a channel state information RS (CSI-RS), etc. The UE 210 transmits one or more random access messages (e.g., a Msg.1) using one or more transmit (Tx) beams corresponding to a selected SSB and/or the CSI-RS and receives one or more random access messages (e.g., a Msg.2) using one or more receive (Rx) beams that is determined/selected during a downlink synchronization phase (e.g., listening for and measuring the SSBs/CSI-RS). Thus, the UE 210 utilizes a same spatial-domain transmission filter as used to receive the SSBs/CSI-RS.

The UE 210 may determine slot configurations using a provided tdd-UL-DL-ConfigurationCommon in a system information block one (e.g., SIB1). However, within the asymmetric TRP deployment 200, the slot patterns of associated or TRPs (e.g., TRP A and TRP B) may be different, and thus, there are different valid UL slots for the UE 210 during random access procedures. In other words, the TRP 220 and the TRP 225 may provide different valid slots for use by the UE 210 during Msg1/Msg3/MsgA transmissions.

In some embodiments, the UE 210 may trigger a random access procedure in response to a triggering event (e.g., initial access, handover, beam failure, and so on) or in response to receiving an indication from a network node (e.g., via a physical downlink control channel (PDCCH) order message). Initially, the UE 210 receives and measures the reference signal resource power (RSRP) of the SSBs/CSI-RS transmitted (periodically) from the TRPs 220, 225. In some cases, the UE 210 may receive an indication of the SSB/preamble/RACH occasion (RO) from an TRP via dedicated RRC signaling, dedicated medium access control control element (MAC-CE) signaling, dedicated downlink control information (DCI) signaling, and so on.

The UE 210 selects an SSB/CSI-RS index (e.g., a beam index) with a highest power. The UE 210 may decode system information (e.g., SIB1) contents, including a RACH configuration. For example, the system information may include an indication from the TRP 220 that the TRP 220 is associated with other TRPs (e.g., the TRP 225) that have a UL-only configuration. For example, the system information may include a 1-bit indication, where “‘0” indicates that the TRP 220 is not associated with other UL-only TRPs and “1” indicates that the TRP 220 is associated with other UL-only TRPs (e.g., the TRP 225) having UL-only TDD patterns. As another example, the SIB1 may indicate the tdd-UL-DL-ConfigurationCommon (e.g, a slot DL-UL pattern) of associated UL-only TRPs.

In some embodiments, when the TRP 220 is associated with one or more UL-only TRPs, the SIB1 may indicate a valid RO indicator and/or a valid PUSCH occasion (PO) indicator. For example, the SIB1 may include a bitmap or bitmaps that indicate the valid ROs and/or the valid POs associated with the UL-only TRPs.

The UE 210 transmits one or more random access preambles (e.g., PRACH preambles), via Msg1 during a Type 1 random access procedure or MsgA during a Type 2 random access procedure. The UE 210 may transmit the random access procedure via valid ROs associated with selected/indicated SSBs of the TRP 220. The UE 210 may transmit a Msg1 using a Tx beam corresponding to a Rx beam of a selected or indicated SSB/CSI-RS, where the UE 210 uses a same spatial-domain transmission filter as the filter used to receive a selected or indicated SSB/CSI-RS.

In some cases, the UE 210 repeats the Msg1 transmission for a number of times (e.g., N_{preamble}^{rep}) where the number of times is indicated to the UE 210 via the SIB1, the PDCCH order message, and/or determined by the UE 210 based on an SSB RSRP measurement (e.g., where the N_{preamble}^{rep} increases with a decreasing SSB RSRP). The UE 210 may transmit one or more preambles (e.g., Msg1) using different Tx beams, such as when the SIB1 indicates that the TRP 220 is associated with UL-only TRPs (e.g., the TRP 225) In some cases, the UE 210 may receive an indication of a beam-pattern transmission.

A network node may receive the Msg1 via the TRPs (e.g., via the TRP 220 and/or the TRP 225). Based on the network architecture, the network node may be a centralized processing unit (CPU) that receives measurements from TRPs and/or network information (e.g., load information) and determines or selects TRPs based on the measurements/information. In some cases, the network node may be or include a scheduler entity of a TRP (e.g., the TRP 220). For example, the TRPs may send/share/transmit measurements to the TRP 220 (e.g., via an over-the-air (OTA) interface, an Xn interface, and so on), such as when the measurements are above a certain threshold.

The network node may determine (e.g., based on Msg1 received power measurements at each TRP) the TRP to use for receiving future UL messages (e.g., Msg3) from the UE 210. For example, network node may coordinate with and/or synchronize the associated TRPs, such as facilitate information exchanges (e.g., SSB configurations, RACH configurations) for the TRPs.

For example, when a certain TRP (e.g., TRP 220) has a better or higher Msg1 received power measurement, the network node may determine to direct the UE 210 to transmit its UL communications/Msg3 towards the certain TRP. Thus, even when the UE 210 transmits the random access preamble (e.g., Msg1) on an RO associated with a selected SSB of the TRP 220 using a Tx beam corresponding to an Rx beam of the selected SSB, the TRP 225 may receive the Msg1 with a higher power (with respect to the power of the TRP 220) due to a better channel quality with the UE 210.

The network mode may generate and transmit a random access response (RAR) message (e.g., Msg2) in response to receiving the Msg1 from the UE 210. For example, the network node may transmit the RAR message via the TRP 220 using the same SSB beams used for receiving the Msg1 from the UE 210, while the Msg2 is received by the UE 210 during a time-window using the same spatial-domain filters used to transmit the Msg1.

In some cases, the Msg2 may indicate one or more configuration sets (or identifiers or sets of configurations), where each configuration set contains a time-advance (TA) command, a UL Grant, a UL Tx beam index (in case UE transmits preamble using two or more UL Tx beams), and/or a pathloss offset. Each configuration set may be associated with a TRP index, TRP identifier, or a tdd-UL-DL-ConfigurationCommon configuration index.

For example, when the network node determines to direct the UE 210 to transmit the Msg3 towards a certain TRP (e.g., the TRP 220), network node may indicate, in the Msg2, a set of configurations or identifiers that include a TA command, a UL Tx beam index, and a UL Grant all associated with the TRP index/ID or TRP tdd-UL-DL-ConfigurationCommon configuration index of the certain TRP. In some cases, such as when the certain TRP is a UL-only TRP, the Msg2 may include a pathloss offset that is determined by comparing pathloss values of the associated TRPs (e.g., a difference between pathloss values of the TRP 220 and the TRP 225). The UE 210 may utilize the pathloss offset to determine the UL transmit power of the Msg3. In some cases, the pathloss offset and/or the TA command may be indicated by an index value pointing to a predefined value.

In some embodiments, the network node may determine to direct the UE 210 to transmit the Msg3 to both TRPs 220, 225. Based on the determination, the network node may indicate, in the Msg2, two sets of configurations (e.g., a set of configurations X and a set of configurations Y), where each set of configurations includes a TA command, a pathloss offset, a UL Tx beam index, and a UL Grant associated with the TRP indexes/IDs or TRP tdd-UL-DL-ConfigurationCommon configuration indexes.

In some embodiments, the network node may indicate one set of configurations (via Msg2) as a fallback configuration, where another set of configurations is indicated as a primary set of configurations). The UE 210 may use the fallback configuration when, for example, there is no receipt of a subsequent Msg4 within a predefined time window. In some cases, the network node may indicate to the UE 210 (e.g., in Msg4) to use the fallback configuration.

As described herein, in some embodiments, an asymmetric TRP deployment may include TRPs having different TDD slot patterns.

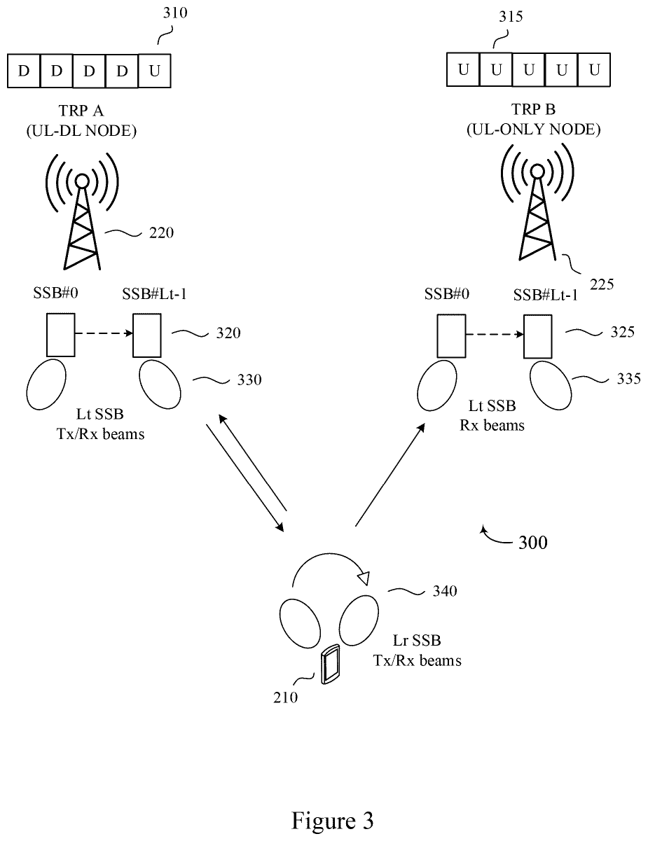

FIG. 3 illustrates an example random access procedure in an asymmetric TRP deployment 300 in accordance with aspects of the present disclosure. The asymmetric TRP deployment 300 may include a TRP 220 associated with a first TDD slot pattern 310, which includes both DL and UL slots, and a TRP 225 associated with a second TDD slot pattern 315, which only includes UL slots. A UE 210 may measure (via one or more (e.g., Lᵣ) SSB Rx beams 340) a receive power of SSBs 320 of the TRP 220 and/or a receive power of SSBs 325 of the TRP 225, and transmit a preamble, via one or more transmit beams 340, to the TRP 220 and the TRP 225, which is received via one or more SSB Rx beams (e.g., Lₜ) 330, 335 at the TRP 220 and the TRP 225.

In some embodiments, such as when the TDD slot patterns 310, 315 are different and the UE 210 is directed to transmit a Msg3 towards the TRP 225 (where the TRP 220 is associated with the selected/indicated SSB 330), the Msg2 may indicate the tdd-UL-DL-ConfigurationCommon of the TRP 225. In some cases, the Msg2 may indicate that the Msg2 configuration set is associated with a TRP (e.g., the TRP 225) with a UL-only TDD pattern (e.g., the TTD patterns 315) using a 1 bit indication (e.g., “0” indicates that a TRP has a same tdd-UL-DL-ConfigurationCommon as the TRP 220 and “1” indicates that the TRP has a UL-only TDD pattern). In some cases, such as when the TRP type indication (e.g., a TRP-type) is not included in the Msg2, the UE 210 may assume that the TRP is configured for UL and DL.

In some cases, the UE 210 may transmit the Msg3 (e.g., a scheduled PUSCH) using one or more sets of configurations (e.g., indicated by Msg2) and may receive the Msg4 using the same spatial-domain filters as used to transmit the Msg1. The UE 210, therefore, may transmit the Msg3 towards the TRP 225 (e.g., via the one or more SSB Rx beams 335) on a slot n, even when the slot n is indicated as DL for the TRP 220, as the slot is indicated as UL for the TRP 225 (e.g., within the TDD pattern 315).

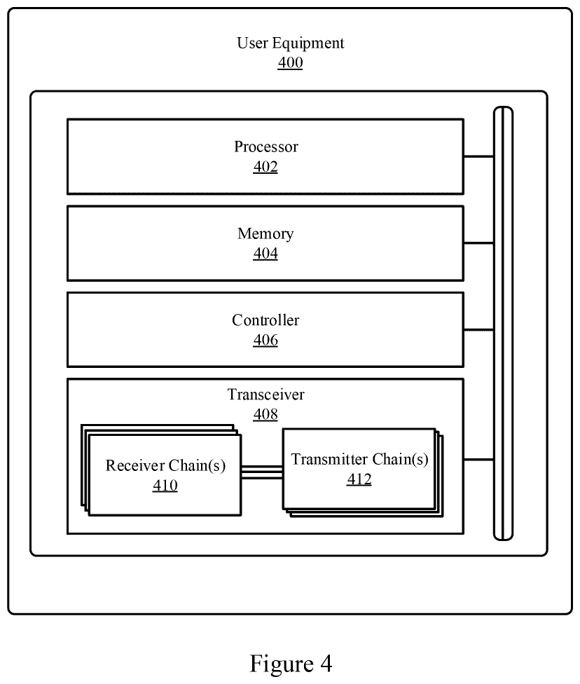

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein.

For example, the processor 402 may support wireless communication at the UE 400 in accordance with examples as disclosed herein. The UE 400 may be configured to support a means for transmitting one or more random access preambles, receiving a random access response message based at least in part on the one or more transmitted random access preambles, wherein the received random access response message indicates one or more identifiers or one or more sets of configurations, wherein each identifier and each set of configurations corresponds to a respective TRP of at least two TRPs, wherein at least one set of configurations for the respective TRP is applicable for downlink and uplink, or wherein the at least one set of configurations for the respective TRP is applicable for uplink, and transmitting a PUSCH transmission to at least one TRP based at least in part on a respective identifier of the at least one TRP or in accordance with the at least one set of configurations for the respective TRP that is indicated in the received random access response message.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 510, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

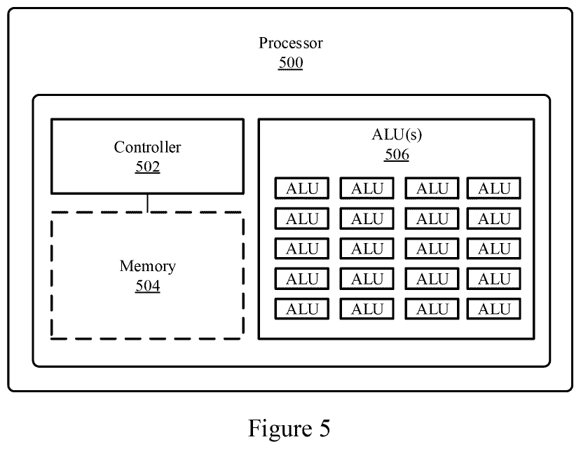

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. For example, the processor 500 may be configured to support a means for transmitting one or more random access preambles, receiving a random access response message based at least in part on the one or more transmitted random access preambles, wherein the received random access response message indicates one or more identifiers or one or more sets of configurations, wherein each identifier and each set of configurations corresponds to a respective TRP of at least two TRPs, wherein at least one set of configurations for the respective TRP is applicable for downlink and uplink, or wherein the at least one set of configurations for the respective TRP is applicable for uplink, and transmitting a PUSCH transmission to at least one TRP based at least in part on a respective identifier of the at least one TRP or in accordance with the at least one set of configurations for the respective TRP that is indicated in the received random access response message.

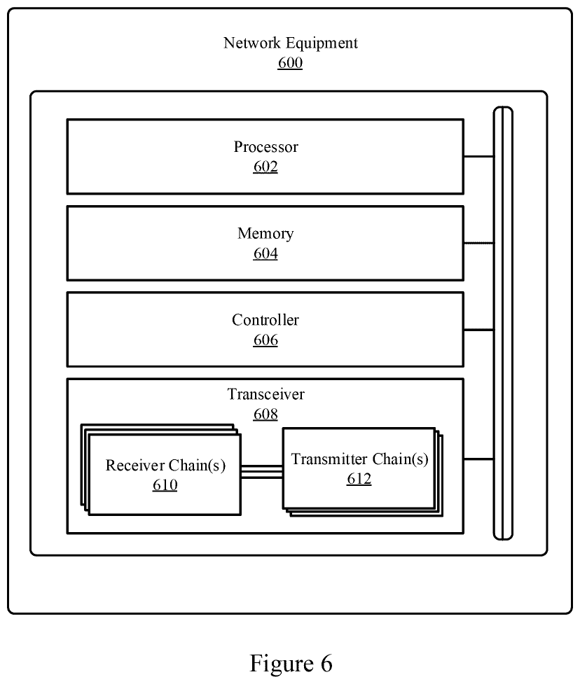

FIG. 6 illustrates an example of a NE 600 in accordance with aspects of the present disclosure. The NE 600 may include a processor 602, a memory 504, a controller 606, and a transceiver 608. The processor 602, the memory 504, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604).

For example, the processor 602 may support wireless communication at the NE 600 in accordance with examples as disclosed herein. The NE 600 may be configured to support a means for receiving one or more random access preambles from a UE and transmitting, to the UE, a random access response message that includes one or more sets of configurations associated with a TRP index, wherein each set of configurations corresponds to a respective TRP of at least two TRPs within the TRP index, wherein at least one set of configurations for the respective TRP is applicable for downlink and uplink, or wherein the at least one set of configurations for the respective TRP is applicable for uplink.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

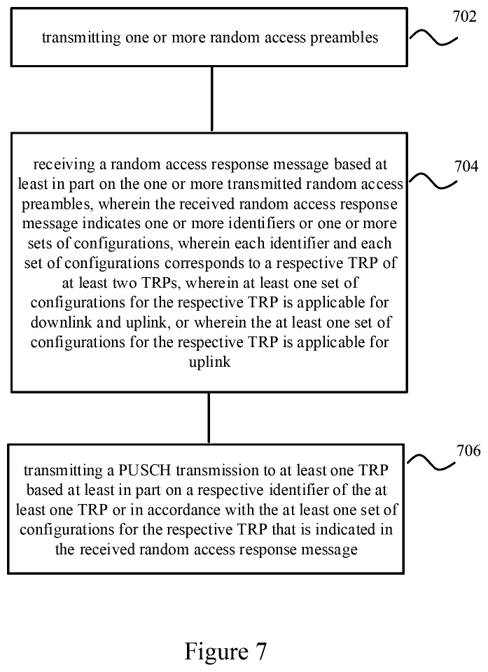

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 702, the method may include transmitting one or more random access preambles. The operations of 702 may be performed in accordance with examples as described herein. In some implementations, aspects of the operations of 702 may be performed by a UE as described with reference to FIG. 4.

At 704, the method may include receiving a random access response message based at least in part on the one or more transmitted random access preambles, wherein the received random access response message indicates one or more identifiers or one or more sets of configurations, wherein each identifier and each set of configurations corresponds to a respective TRP of at least two TRPs, wherein at least one set of configurations for the respective TRP is applicable for downlink and uplink, or wherein the at least one set of configurations for the respective TRP is applicable for uplink. The operations of 704 may be performed in accordance with examples as described herein. In some implementations, aspects of the operations of 704 may be performed by a UE as described with reference to FIG. 4.

At 706, the method may include transmitting a PUSCH transmission to at least one TRP based at least in part on a respective identifier of the at least one TRP or in accordance with the at least one set of configurations for the respective TRP that is indicated in the received random access response message. The operations of 706 may be performed in accordance with examples as described herein. In some implementations, aspects of the operations of 704 may be performed by a UE as described with reference to FIG. 4.

It should be noted that the method described herein describes a possible implementation, and that the operations and the steps may be rearranged or otherwise modified and that other implementations are possible.

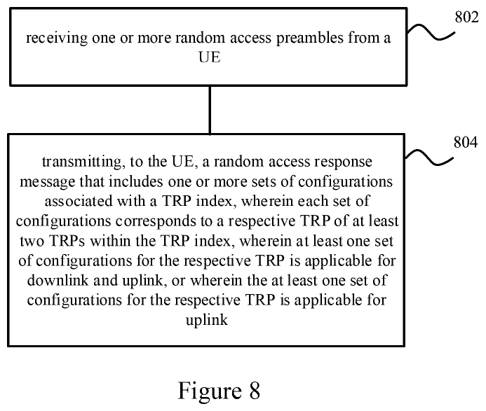

FIG. 8 illustrates a flowchart of a method in accordance with aspects of the present disclosure. The operations of the method may be implemented by an NE as described herein. In some implementations, the NE may execute a set of instructions to control the function elements of the NE to perform the described functions.

At 802, the method may include receiving one or more random access preambles from a UE. The operations of 802 may be performed in accordance with examples as described herein. In some implementations, aspects of the operations of 902 may be performed by an NE as described with reference to FIG. 6.

At 804, the method may include transmitting, to the UE, a random access response message that includes one or more sets of configurations associated with a TRP index, wherein each set of configurations corresponds to a respective TRP of at least two TRPs within the TRP index, wherein at least one set of configurations for the respective TRP is applicable for downlink and uplink, or wherein the at least one set of configurations for the respective TRP is applicable for uplink. The operations of 804 may be performed in accordance with examples as described herein. In some implementations, aspects of the operations of 804 may be performed by an NE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
transmit one or more random access preambles;
receive a random access response message based at least in part on the one or more transmitted random access preambles,
wherein the received random access response message indicates one or more identifiers or one or more sets of configurations,
wherein each identifier and each set of configurations corresponds to a respective transmission and reception point (TRP) of at least two TRPs,
wherein at least one set of configurations for the respective TRP is applicable for downlink and uplink; or
wherein the at least one set of configurations for the respective TRP is applicable for uplink; and
transmit a physical uplink shared channel (PUSCH) transmission to at least one TRP based at least in part on a respective identifier of the at least one TRP or in accordance with the at least one set of configurations for the respective TRP that is indicated in the received random access response message.

2. The UE of claim 1, wherein the at least one processor is further configured to cause the UE to:
receive system information from a first TRP of the at least two TRPs, wherein the system information indicates that the first TRP is associated with a second TRP of the at least two TRPs, wherein the first TRP is associated with a first set of configurations applicable for downlink and uplink, and wherein the second TRP is associated with a second set of configurations applicable for uplink,
wherein the one or more random access preambles are transmitted to the at least two TRPs based at least in part on the received system information and using at least one beam or at least two beams, wherein each beam is associated with one or both of the at least two TRPs.

3. The UE of claim 2, wherein the system information further indicates one or more of a slot pattern associated with the second TRP, a valid random access occasion associated with the second TRP, an invalid random access occasion associated with the second TRP, a valid PUSCH occasion associated with the second TRP, or an invalid PUSCH occasion associated with the second TRP.

4. The UE of claim 2, wherein the system information comprises a system information block one (SIB1), wherein the SIB1 includes at least one information element (IE) comprising a Boolean type, wherein a first Boolean value for the IE is indicative of the first TRP being associated with a second TRP, and wherein a second Boolean value for the IE is indicative of the first TRP having no association to the second TRP.

5. The UE of claim 1, wherein each set of configurations comprises one or more of a timing advance (TA) command, an uplink transmit beam index, a pathloss offset, or an uplink grant.

6. The UE of claim 1, wherein the at least one processor is further configured to cause the UE to:
identify a pathloss offset based at least in part on the received random access response message; and
determine a transmit power for the PUSCH transmission based at least in part on the identified pathloss offset,
wherein the PUSCH transmission is transmitted to the at least one TRP according to the determined transmit power.

7. The UE of claim 1, wherein the at least one processor is further configured to cause the UE to:
identify at least two set of configurations based at least in part on the received random access response message, wherein a first set of configurations of the at least two set of configurations is applicable for downlink and uplink, and wherein a second set of configurations of the at least two set of configurations is applicable for uplink,
wherein, to transmit to the at least one TRP, the at least one processor is further configured to cause the UE to:
transmit a first PUSCH transmission to a first TRP of the at least two TRPs in accordance with the first set of configurations; and
transmit a second PUSCH transmission to a second TRP of the at least two TRPs in accordance with the second set of configurations.

8. The UE of claim 7, wherein the received random access response message includes at least one information element (IE) comprising a Boolean type that indicates whether the second TRP has a same set of configurations as the first TRP, wherein a first Boolean value for the IE is indicative of the second TRP having the same set of configurations as the first TRP, and wherein a second Boolean value for the IE is indicative of the second TRP having a different set of configurations than the first TRP.

9. The UE of claim 8, wherein an absence of the IE comprising the Boolean type that indicates whether the second TRP has the same set of configurations as the first TRP from the received random access response message is indicative of the second TRP having the same set of configurations as the first TRP.

10. The UE of claim 7, wherein the first set of configurations and the second set of configurations are the same.

11. The UE of claim 1, wherein at least one set of configurations of the one or more sets of configurations is indicated as a fallback configuration set.

12. The UE of claim 11, wherein the at least one processor is further configured to cause the UE to transmit the PUSCH message to the at least one TRP based on the fallback configuration set when a Msg4 is not received within a pre-defined time window or in response to an indication within a received Msg4.

13. The UE of claim 1, wherein the received random access response message includes an indication of a tdd-UL-DL-ConfigurationCommon defining slots pattern for at least one UL-only TRP of the at least two TRPs.

14. The UE of claim 1, wherein the received random access response message includes a TRP-Type indication that indicates a provided configuration set is associated with a TRP having a UL-only time division duplex (TDD) pattern.

15. A network entity for wireless communication, comprising:
at least one memory; and
at least one processor coupled with the at least one memory and configured to cause the network entity to:
receive one or more random access preambles from a user equipment (UE); and
transmit, to the UE, a random access response message that includes one or more sets of configurations associated with a transmission and reception point (TRP) index,
wherein each set of configurations corresponds to a respective TRP of at least two TRPs within the TRP index,
wherein at least one set of configurations for the respective TRP is applicable for downlink and uplink; or
wherein the at least one set of configurations for the respective TRP is applicable for uplink.

16. The network entity of claim 15, wherein the at least one processor is further configured to cause the network entity to signal, via a system information block (SIB):
an indication that a downlink (DL) serving TRP of a corresponding synchronization signal block (SSB) is associated with at least one UL-only TRP of the at least two TRPs;
a tdd-UL-DL-ConfigurationCommon defining slots pattern of the at least one associated UL-only TRP;
a valid RACH Occasion (RO) indicator validating and invalidating one or more ROs corresponding to the at least one UL-Only TRP;
a valid PUSCH Occasion (PO) indicator validating and invalidating one or more POs corresponding to the at least one UL-Only TRP;
or combinations thereof.

17. The network entity of claim 15, wherein at least one set of configurations is indicated as a fallback configuration set.

18. The network entity of claim 15, wherein each set of configurations contains a time-advance (TA) command, an uplink (UL) grant, a UL transmit beam index, and a pathloss offset.

19. A method performed by a user equipment (UE), the method comprising:
transmitting one or more random access preambles;
receiving a random access response message based at least in part on the one or more transmitted random access preambles,
wherein the received random access response message indicates one or more identifiers or one or more sets of configurations,
wherein each identifier and each set of configurations corresponds to a respective transmission and reception point (TRP) of at least two TRPs,
wherein at least one set of configurations for the respective TRP is applicable for downlink and uplink; or
wherein the at least one set of configurations for the respective TRP is applicable for uplink; and
transmitting a physical uplink shared channel (PUSCH) transmission to at least one TRP based at least in part on a respective identifier of the at least one TRP or in accordance with the at least one set of configurations for the respective TRP that is indicated in the received random access response message.

20. A method performed by a network entity, the method comprising:
receiving one or more random access preambles from a user equipment (UE); and
transmitting, to the UE, a random access response message that includes one or more sets of configurations associated with a transmission and reception point (TRP) index,
wherein each set of configurations corresponds to a respective TRP of at least two TRPs within the TRP index,
wherein at least one set of configurations for the respective TRP is applicable for downlink and uplink; or
wherein the at least one set of configurations for the respective TRP is applicable for uplink.
